(19) United States
(12) Patent Application Publication
(10) Pub. No.: US 2004/0187701 A1
(43) Pub. Date: Sep. 30, 2004

(54) Device for skewering food

(76) Inventor: Steve Oi, Vernon Hills, IL (US)

Correspondence Address: Steve Oi, 244 E. Baltusrol Drive, Vernon Hills, IL, 60061, US

(21) Appl. No.: 10/401,852

(22) Filed: Mar. 31, 2003

(51) Int. Cl. A47J 37/04

(52) U.S. Cl. 99/419

(57) ABSTRACT

Device which holds pieces of food so that a skewer may be inserted to form a skewer of food. Device comprises a base receptacle with a hinged cover lid. The base receptacle has a trough for holding several pieces of food. One end of the base receptacle has a V-shaped channel to guide a skewer inserted into the device. When the cover lid is closed onto the base receptacle, a wedge on the underside of the cover lid is lowered across the V-shaped channel, forming a path to guide a skewer through the approximate center of the pieces of food in the trough. An indentation at the opposite end of the trough allows the tip of the skewer to pierce through the last piece of food but not to the outside of the device. Sectional spacers shorten the length of the trough to create shorter skewers of food.

### CROSS-REFERENCE TO RELATED APPLICATIONS

Not Applicable.

### STATEMENT REGARDING FEDERALLY SPONSORED RESEARCH OF DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

This invention relates to food preparation equipment, and more specifically, to a device for skewering food which enables food preparers to easily and safely prepare food on skewers, commonly referred to as shish kebabs, kebabs and satay, for grilling or barbecuing.

Grilling food on skewers, particularly meat such as beef, chicken and pork, is a practice that is almost as old as fire itself, and is native to numerous cultures around the world, including cultures in and around Asia, the Middle East, India and the Mediterranean. While common among these cultures, grilled meats on skewers are enjoyed around the world. In the United States grilled meats on skewers are available in a variety of restaurants. These grilled meats on skewers include, but are not limited to:

Shish kebabs or kebabs—grilled chunks of marinated beef, lamb, pork, chicken, seafood, vegetables or fruit on skewers—served in restaurants serving American food, seafood, Greek and other cuisines.

Satay—grilled pieces of marinated pork, chicken, or beef on skewers—served in Thai and other Asian cuisine restaurants.

Yakatori and other “-tories”—grilled chunks of chicken, seafood or beef on skewers—served in Japanese restaurants.

The practice of grilling meats and other foods on skewers is not limited to restaurants. Food on skewers are prepared and grilled by consumers on indoor and outdoor grills heated by charcoal, natural gas, propane, wood, and electricity. Skewers made of wood such as bamboo or of metal are relatively inexpensive and readily available in grocery stores and other retail establishments for consumers to purchase and use. Commercially-prepared marinades and sauces are also plentiful, and many consumers prepare their own home-made marinades and sauces for grilling meat on skewers.

However, the preparation of meat and other foods on skewers is not a trivial task. Preparing meat on skewers can be labor-intensive, time-consuming, tricky, and potentially dangerous:

Chunks of meat, vegetables, or fruit are typically skewered by hand one chunk at a time, with one hand holding a chunk of meat while the other hand guides a sharp skewer through the approximate center of the chunk of food, or with one hand holding a skewer and the other hand guiding a chunk of food onto the sharp tip of the skewer. Each chunk of food is then slid down the skewer into its desired position.

Guiding a sharp skewer through a chunk of food requires some degree of skill and concentration. Sub-optimal placement of the food onto a skewer may result in the food falling off the skewer during grilling and/or an unattractive appearance (e.g., the meat does not appear uniform on the skewer).

Skewers are typically sharp sticks and can be potentially dangerous if improperly handled. The sharp tip of the skewer must be forced into and slid through a chunk of food, and if the proper skill and control is not applied, injuries may result such as cuts, scrapes, puncture wounds or lacerations to the fingers or hands. In extreme cases, a skewer may be accidentally poked through a finger or hand.

A variety of devices have been developed in the prior art which purport to make the preparation of meat on skewers easier and safer. However, these devices in the prior art may be:

Improved to be safer to use, as some of these devices (Anderson U.S. Pat. No. 5,174,195; Walls U.S. Pat. No. 4,429,435; Castens U.S. Pat. No. 5,100,366) permit the sharp tip of the skewer(s) to slide through the device, thus protruding outside the device, posing a potential safety hazard to the food preparer;

Made simpler in design and easier to use, as some of these devices (Anderson U.S. Pat. No. 5,174,195; Castens U.S. Pat. No. 5,100,366) feature individual compartments for each chunk of meat and in the case of Anderson (U.S. Pat. No. 5,174,195), removable inserts which must be removed and repositioned in order to adjust each compartment. Care must be used to place each chunk of meat in each separate compartment. Also, extra care must be used when cleaning the numerous compartments and parts to maintain proper sanitation;

Made to be more precise for skewering food, as some of these devices provide a slot or channel to guide skewers, but these slots and channels are designed to accommodate skewers of a fixed diameter. If the skewer is smaller in diameter than the slot or channel, the skewer may be inserted at an angle into the chunks of meat so as not to be in the approximate center of the finished skewer of meat. If the diameter of the skewer is too large, the skewer may not be used in the device or the device may not work properly. Anderson (U.S. Pat. No. 5,174,195) proposes to provide separate slots for different diameter skewers, but these slots are of a fixed diameter and can only accommodate the skewers of the appropriate diameter.

### BRIEF SUMMARY OF THE INVENTION

This invention is a device which holds pieces of food, such as pieces of meat, so that a skewer may be inserted thru the approximate center of the pieces to form a skewer of food, such as a shish kebab, kebab or satay.

The device is comprised of a base receptacle, which holds several, adjacent chunks of food in a linear formation, and a hinged cover lid which when closed onto the base receptacle, forms a guide channel on one end of the device which guides a skewer inserted into the device through the approximate center of each piece of food, forming a skewer of food.

The device provides a relatively safer means of preparing food on skewers in that food is pierced by the skewer inside the device, reducing the risk of injury. Moreover, the device does not permit the sharp tip of the skewer to slide through to the outside of the device, thereby reducing the risk of injury. The base receptacle features a V-shaped channel on one end where the skewer is inserted into the device and is enclosed on the other end so that the skewer does not poke through the other side of the device.

The device is simple in design and simple to use. Pieces of food of the approximate height and width of the receptacle are placed next to each other in the receptacle. The hinged cover lid is closed onto the receptacle and a wedge on the underside of the cover lid is lowered across a V-shaped channel in the base receptacle, forming a guide path for a skewer to be inserted and pushed into the device and through the approximate center of the pieces of food in the base receptacle. The hinged cover lid allows the device to accommodate a range of diameters of skewers, as the wedge on the underside of the lid can rest on skewers at a number of different angles, thus providing some flexibility in the type and thickness of skewer that a food preparer can utilize in the device. Additionally, one or more sectional spacers of varying lengths which fit the base receptacle allows the device to produce skewers of food of varying lengths. An indentation in the enclosed end of the inside of the base receptacle permits the piece of food on that end to be pierced such that the tip of the skewer protrudes from that piece of food, without the tip protruding through the end of the device, as that end of the device is enclosed.

### BRIEF DESCRIPTION OF THE SEVERAL VIEWS OF THE DRAWING

FIG. 1. is a perspective view looking down into the inside of the device with the cover lid open;

FIG. 2. is a perspective view looking down into the inside of the device with a cutaway view of the cover lid in the closed position showing a partially inserted skewer;

FIG. 3. is a longitudinal cross-section side view with a skewer inserted through pieces of food;

FIG. 4. is a cross-section view of the insertion end of the device showing an inserted skewer;

FIG. 5. is a cross-section view of the insertion end of the device showing an inserted skewer of a larger diameter;

FIG. 6. is a perspective cross-section cutaway view of the device near the terminal end;

FIG. 7. is a perspective side view of a sectional spacer;

FIG. 8. is a longitudinal cross-section side view of the device with sectional spacers inserted.

### DETAILED DESCRIPTION OF THE INVENTION

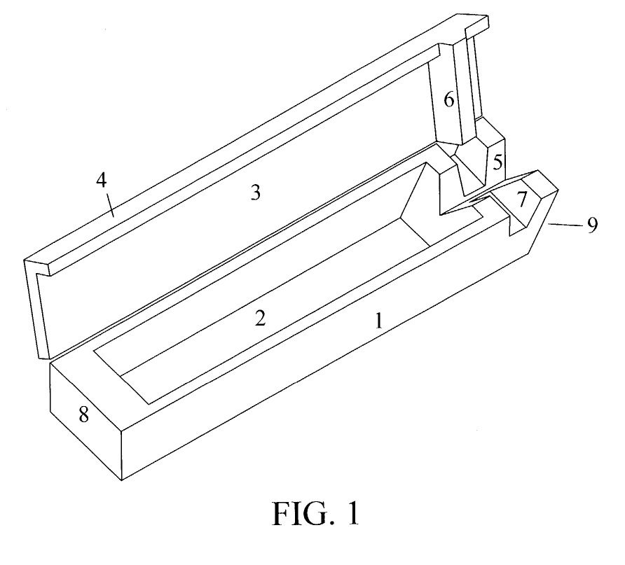

A preferred form of the device for skewering food is shown in FIG. 1. The device is comprised of a base receptacle I and hinged cover lid 3. The base receptacle l consists of a trough 2 which extends most of the length of the base receptacle 1. At the insertion end 9 of the base receptacle is a V-shaped channel 5 which runs from that end of the base receptacle 1 to the edge of the trough 2. A wedge channel 7 runs perpendicular across the V-shaped channel 5. On the opposite end of the receptacle is the terminal end 8 of the device.

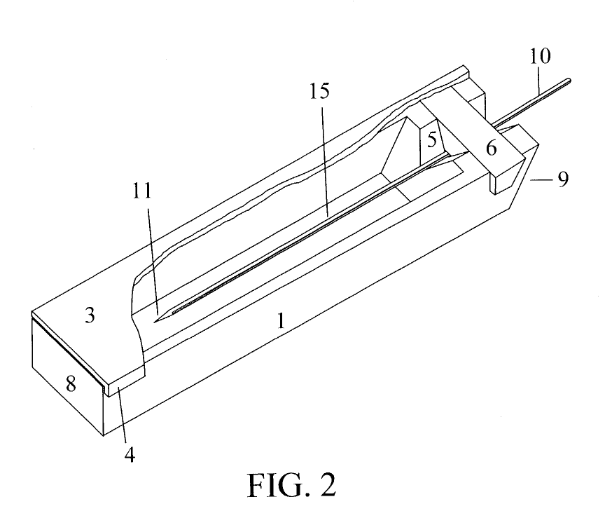

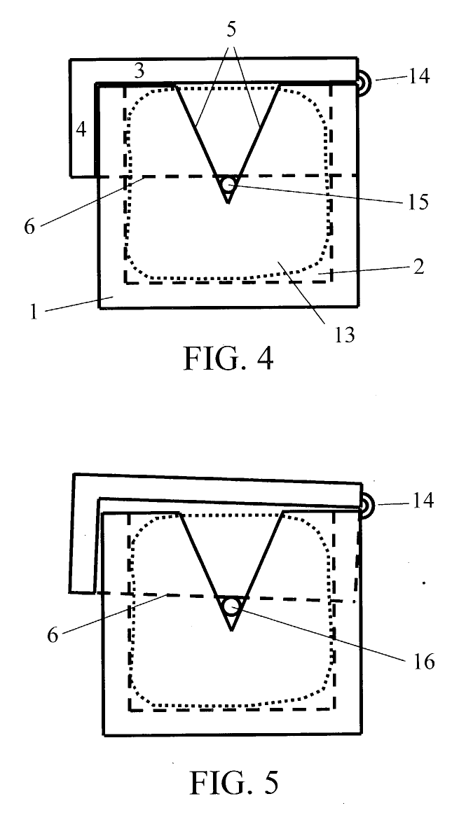

The cover lid 3 is attached to the base receptacle 1 by means of one or more hinges such as hinge 14 illustrated in FIG. 4. The cover lid 3 sits on top of the base receptacle when in the closed position (see FIG. 2). The cover lid 3 features a wedge 6 (see FIGS. 1-5) located on the underside of the cover lid on the end which corresponds to the wedge channel 7 in the base receptacle 1 (see FIG. 1). When the cover lid 3 is closed onto the base receptacle, the wedge lies down across the V-shaped channel of the base receptacle to form a guide channel to guide a skewer into the device.

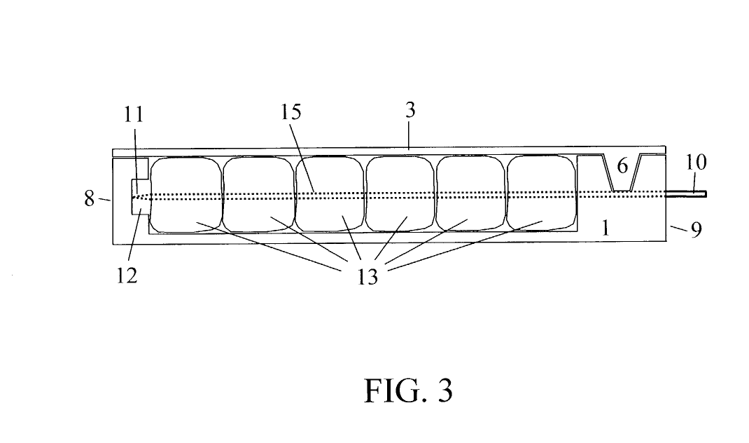

To make a skewer of food, pieces of food that have been cut to the approximate height and width of the trough 2 are placed adjacent to each other into the trough 2 (see FIG. 3). The cover lid 3 is then closed onto the base receptacle land held in the closed position by one of the food preparer's hands. A skewer 15 is inserted into the V-shaped channel on the insertion end 9 (see FIG. 4) and is pushed under the wedge 6 which is sitting across the V-shaped channel and enters the trough 2 of the base receptacle 1 and pierces each piece of food 13 in the approximate center of each piece. The skewer 15 pierces the last piece of food 13 nearest the terminal end 8 of the device and pushes through the last piece and emerges into the indentation 12 of the terminal end 8 (see FIG. 3, 6), the tip of the skewer 11 protruding from the last piece of food but still contained within the inside of the device, thus reducing the risk of injury to the food preparer. The lip 4 of the cover lid 13 (see FIG. 2) also serves to cover the pieces of food and reduce the risk of a skewer straying outside the device. Once a skewer of food has been made, the cover lid is opened and the skewer of food can be removed.

The hinged design of the cover lid 3 allows the device to accommodate a range of diameters of skewers (see FIGS. 4, 5). The wedge 6 when placed across the V-shaped channel 5 and onto a skewer creates a guide channel which directs a skewer into the device. To accommodate a skewer with a larger diameter, the cover lid 3 and the wedge 6 sit on top of the skewer in the V-shaped channel at a slight angle (see FIG. 5), still forming a guide channel while covering the pieces of food to reduce the risk of a skewer straying outside the device.

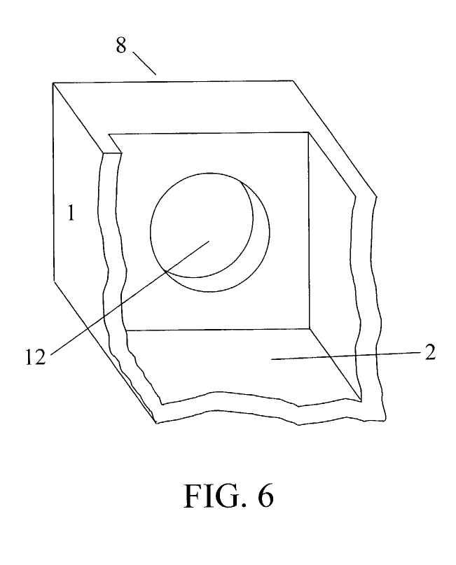

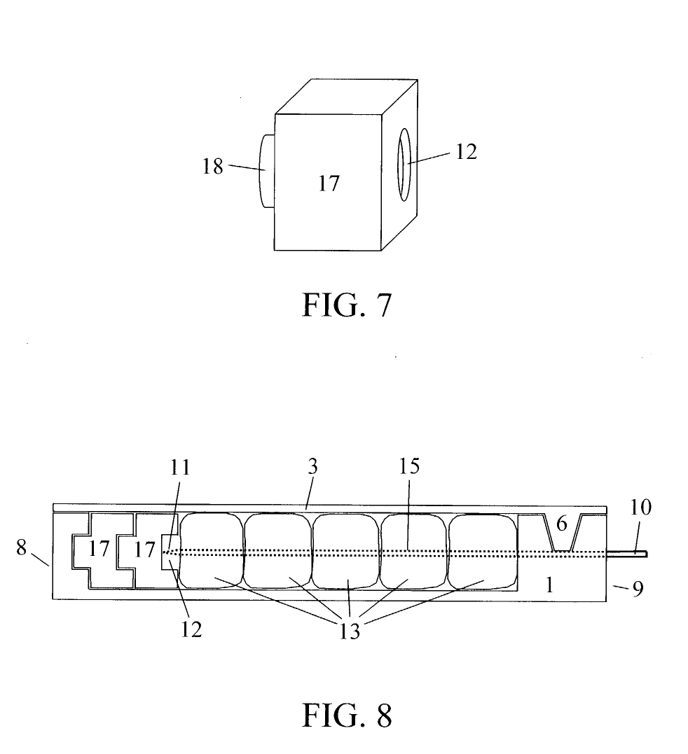

Sectional spacers 17 (see FIGS. 7, 8) are used to shorten the length of the trough 2 (see FIG. 8) so that shorter skewers of food may be produced by the device. Sectional spacers are shaped and dimensioned similarly to the height and width of the trough 2 of the base receptacle 1. On one end of the sectional spacer 17 is an indentation 12 (see FIG. 7) similar to the indentation on the inside surface of the terminal end of the device (see FIG. 6), and on the opposite end of the sectional spacer 17 is a protrusion 18 that corresponds in size and shape to the indentation 12, thus permitting the sectional spacer to plug into the indentation 12 in the terminal end of the device as well as into the indentations in other sectional spacers (see FIG. 7).

The device and its parts may be made of a suitable material such as plastic which is safe for food preparation, durable, dishwasher safe and relatively inexpensive to manufacture. Additionally, the device may be made in varying sizes and shapes so as to produce skewers of food of varying sizes and shapes. For example, the trough of the base receptacle may be shorter in height than the width of the trough, thus producing skewers of food that are flatter in shape.

The approximate dimensions of a preferred embodiment of this device are as follows:

The length, width and height of the base receptacle is 10 inches, 1.5 inches and 1.5 inches, respectively. The termination end of the base receptacle is 1 inch in length. The trough of the base receptacle is 7.5 inches long, excluding the depth of the indentation, 1 inch wide and 1 inch deep. Thus, the side and bottom walls of the trough are 0.25 inches thick. The indentation is 0.5 inches in diameter and 0.5 inches deep.

The insertion end of the base receptacle which contains the V-shaped channel and the wedge channel is 1.5 inches in length. The V-shaped channel is slightly more than 0.5 inches wide and slightly more than 0.5 inches deep, so that when a skewer is placed in the channel, the center of the skewer is centered with the height and width of the trough. The V-shaped channel is angled at 60 degrees.

The wedge channel is perpendicular to the V-shaped channel. The wedge channel is U-shaped and is 0.5 inches wide and slightly less than 0.5 inches deep.

The cover lid is 10 inches long, 1.75 inches wide and 0.25 inches deep, excluding the depth of the lip. The lip is 0.5 inches in height and 0.25 in thickness. The wedge on the underside of the cover lid is U-shaped and located above the wedge channel in the base receptacle. The dimensions of the wedge correspond to the dimensions of the wedge channel in the base receptacle—0.5 inches in width and less than 0.5 inches in depth.

The sectional spacers are 1 inch long, wide and high. The indentation in each spacer is 0.5 inches in diameter and 0.5 inches deep. The protrusion on each spacer is dimensioned to fit the indentations.

Although the description above contains many specifics, these should not be construed as limiting the scope of the invention, but merely providing illustration of some of the presently preferred embodiments of this invention.

1. What I claim as my invention is a device for holding pieces of food such that a skewer may be inserted through the approximate center of the pieces of food to form a skewer of food, comprising:
A base receptacle which features a trough in which pieces of food may be placed adjacent to each other in a linear formation;
Said base receptacle having a V-shaped channel which leads from the insertion end of the device to the trough, and a wedge channel which is perpendicular to the V-shaped channel. When the cover lid is closed, a wedge on the underside of the cover lid is lowered onto the wedge channel, forming a guide channel which directs a skewer inserted into the V-shaped channel through the approximate center of the pieces of food in the trough;
Said base receptacle having an enclosed end opposite the end with the V-shaped channel. The enclosed end has an indentation on the inside of the trough which is of a smaller size than the height and width of the trough, such that a skewer will pierce through the last piece of food in the trough and protrude from the end of the completed skewer of food, without piercing through the end of the device, as that end is enclosed;
A hinged cover lid which features a wedge on its underside on the end which corresponds to the wedge channel on the base receptacle. When in the closed position, the hinged cover lid covers the food in the trough of the base receptacle and presses the wedge across the V-shaped channel in the base receptacle, forming a guide channel in which a skewer can be inserted and driven into the pieces of food in the trough such that the skewer pierces through the approximate center of each piece of food. The hinged design of the cover lid allows the device to accommodate a range of diameters of skewers;
Said hinged cover lid having a lip which runs the length of the side opposite the hinge. When the hinged cover lid is in the closed position, the lip provides an additional barrier reducing the risk of a skewer sliding out of the device and posing a safety hazard to the food preparer; and
Sectional spacers which fit into the trough of the base receptacle and effectively shorten the length of the trough so as to create skewers of food of shorter lengths. The sectional spacers have indentations similar to the indentation in the terminal end of the trough of the base receptacle and serve the same function of permitting the tip of the skewer to pierce the last piece of food in the trough and protrude through the piece of food while not protruding through the end of the device. The sectional spacers have a protrusion on the opposite side of the indentation and the protrusion is similarly dimensioned to fit into the indentation of the terminal end of the trough of the base receptacle or the indentation of any other sectional spacers.
